(19) United States
(12) Patent Application Publication
(10) Pub. No.: US 2023/0342721 A1
(43) Pub. Date: Oct. 26, 2023

(54) FACILITATED ONLINE BRAINSTORMING TOOL

(71) Applicant: SPARKTANK TECHNOLOGIES PTY LTD, Cleveland, Queensland (AU)

(72) Inventor: Jo LANGHAM, Cleveland, Queensland (AU)

(21) Appl. No.: 18/002,720

(22) PCT Filed: Jun. 22, 2021
(86) PCT No.: PCT/AU2021/050647

§ 371 Date: Dec. 21, 2022

(30) Foreign Application Priority Data
Jun. 22, 2020 (AU) 2020902069

(51) Int. Cl. G06Q 10/101

(52) U.S. Cl. CPC G06Q 10/101

(57) ABSTRACT

A facilitated online ideation (e.g. brainstorming) method and system is provided that is efficient and easy to use, and without requiring a facilitator, or participants with specialised training or experience. The method includes receiving, on a data interface, details of a challenge; receiving, on the data interface, a plurality of focus areas relating to the challenge; and automatically allocating participants to each of the plurality of focus areas. Ideas relating to an allocated focus area of each of the participants are received, on the data interface, and from each of the participants, and participants are automatically allocated to ideas for review of the ideas.

### TECHNICAL FIELD

The present invention relates to ideation, collaboration and brainstorming, and in particular to facilitated online or digital brainstorming and ideation tools.

### BACKGROUND

Brainstorming is a group activity in which efforts are made to find a solution to a specific problem by gathering and developing ideas contributed by members of the group. Creativity for solution development is triggered through the use of specific cues, triggers or prompts to challenge the thinking of individuals in the group. While there are various specific brainstorming techniques, in conventional brainstorming, a facilitator uses various tools such as sticky notes and white boards to collect and organize ideas of the members.

A problem with such brainstorming of the prior art is that it is inefficient. As an illustrative example, it requires people to be together in the same room, which in turn limits who may take part in a brainstorming session and is inefficient for those taking part in the brainstorming.

Attempts have been made to take brainstorming online, e.g. using video conferencing tools or shared virtual white boards. While such approaches alleviate the need for all parties to be present at a single physical location, a problem with such approach is that it is generally more difficult for parties to collaborate by video conferencing than being in a room together, leading to additional inefficiencies in the brainstorming process.

A further problem with brainstorming of the prior art, whether online or in person, is that it is difficult to facilitate such brainstorming sessions. Specialised training is available for facilitators to be able provide the guidance needed to get people to work together in a collaborative manner, to ensure that problems are well defined, and that participants do not deviate from the task at hand. This skill is a part of professional design practice and is usually acquired through training in a trade apprenticeship or through university education.

Certain tools exist which provide a platform for idea collection and collaboration. These tools may provide an alternative to sticky notes and white boards, but they often still rely on the capability of a trained facilitator, or experienced participants, to manage the group process and drive outcomes.

Similar problems exist with other methods of ideation. As such, there is clearly a need for improved ideation tools.

It will be clearly understood that, if a prior art publication is referred to herein, this reference does not constitute an admission that the publication forms part of the common general knowledge in the art in Australia or in any other country.

### SUMMARY OF INVENTION

The present invention is directed to ideation (e.g. brainstorming) tools, methods and systems, which may at least partially overcome at least one of the abovementioned disadvantages or provide the consumer with a useful or commercial choice.

With the foregoing in mind, the present invention in one form, resides broadly in a facilitated online ideation method including:
receiving, on a data interface, details of a challenge;
receiving, on the data interface, a plurality of focus areas relating to the challenge;
automatically allocating participants to each of the plurality of focus areas for ideation;
receiving, on the data interface, and from each of the participants, ideas relating to an allocated focus area of each of the participants; and
automatically allocating participants to each of the ideas for review of the ideas.

Advantageously, the method enables ideation (e.g. brainstorming) to be provided in an efficient and easy to use manner, and without requiring a facilitator, or participants with specialised training or experience. It does not require participants to travel to a common location, or even be available at a single point of time and is not limited in group size. As such, it enables more people to participate in brainstorming, and on different aspects, in a coordinated manner.

The ideation method may comprise brainstorming, “brainwriting” or improvisation methods.

Preferably, participants are allocated to the ideas for review according to their focus area. Participants allocated to one focus area may be allocated to an idea for review from another focus area. Such configuration may ensure that ideas are reviewed and recombined/recreated with a fresh set of eyes (providing unexpected connections and insights).

A participant of the participants may be allocated to an idea for review at least in part according to a focus area selected by the participant.

The participants may be prompted to expand on the ideas for review. As such, ideas may be developed by multiple participants at different points of time.

The participants may be prompted to rate the idea for review. The rating may comprise a rating of a plurality of pre-defined rating options.

The participants may be prompted to rate the idea for review according to a plurality of pre-defined characteristics. The characteristics may include feasibility, creativity, cost and desirability.

A leader board of ideas may be generated for the challenge based upon ratings of the ideas.

Preferably, the method includes receiving on the data interface, details of a plurality of challenges.

The method may include rating participants according to a rating of their ideas in relation to multiple challenges.

A leader board of participants may be generated according to their respective ratings.

The method may include allocating participants to a challenge of the plurality of challenges. The participants may be allocated to a challenge at least in part according to their previous activity (e.g. experience). The participants may be allocated to a challenge at least in part according to their respective rating.

The participants may be prompted to enter details of a plurality of draft ideas prior to enter details of a final idea.

A challenge administrator (creator or host) may be prompted to enter the details of the challenge. The details of the challenge may include a problem statement and one or more obstacles.

The details of the challenge may include details of who is affected by the problem.

The details of the challenge may include details of assumptions associated with the problem.

The method may include automatically generating one or more suggested focus areas according to the details of the challenge. The plurality of focus areas may be selected at least in part according to the one or more suggested focus areas.

The one or more suggested focus areas may be generated according to artificial intelligence and/or machine learning algorithms.

The participants may be in different geographic regions. The participants may perform steps of the method at different points of time.

In some embodiments, the participants may perform steps of the method simultaneously. A clock or timer may be used to ensure that participants perform the steps simultaneously.

In another form, the invention resides broadly in a facilitated online ideation system including:
a data interface, for:
   receiving details of a challenge; and
   receiving a plurality of focus areas relating to the challenge; and
a processor, configured to:
   automatically allocate participants to each of the plurality of focus areas for ideation;
wherein the data interface is further configured to receive, from each of the participants, ideas relating to an allocated focus area of each of the participants and wherein the process is further configured to automatically allocate participants to each of the ideas for review of the ideas.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a facilitated online brainstorming system, according to an embodiment of the present invention.

FIG. 2 illustrates an exemplary data structure of a server of the system of FIG. 1, according to an embodiment of the present invention.

FIG. 3 illustrates a simplified exemplary scenario of the system of FIG. 1, which is described with reference to FIGS. 1 and 4-13.

FIG. 4 illustrates a screenshot of a problem description screen of the system of FIG. 1, according to an embodiment of the present invention.

FIG. 5 illustrates a screenshot of a problem impact screen of the system of FIG. 1, according to an embodiment of the present invention.

FIG. 6 illustrates a screenshot of a problem assumptions screen of the system of FIG. 1, according to an embodiment of the present invention.

FIG. 7 illustrates a screenshot of a problem focus areas screen of the system of FIG. 1, according to an embodiment of the present invention.

FIG. 8 illustrates a screenshot of a challenge introduction screen of the system of FIG. 1, according to an embodiment of the present invention.

FIG. 9 illustrates a screenshot of a problem detail screen of the system of FIG. 1, according to an embodiment of the present invention.

FIG. 10 illustrates a screenshot of an idea creation screen of the system of FIG. 1, according to an embodiment of the present invention.

FIG. 11 illustrates a screenshot of an idea development screen of the system of FIG. 1, according to an embodiment of the present invention.

FIG. 12 illustrates a screenshot of a first ideas expansion screen of the system of FIG. 1, according to an embodiment of the present invention.

FIG. 13 illustrates a screenshot of a second ideas expansion screen of the system of FIG. 1, according to an embodiment of the present invention.

FIG. 14 illustrates a screenshot of an idea rating screen of the system of FIG. 1, according to an embodiment of the present invention.

FIG. 15 illustrates a screenshot of an idea leader board screen of the system of FIG. 1, according to an embodiment of the present invention.

FIG. 16 illustrates a screenshot of a bonus timed challenge screen of the system of FIG. 1, according to an embodiment of the present invention.

FIG. 17 illustrates a screenshot of a live challenge scheduling screen of the system of FIG. 1, according to an embodiment of the present invention.

FIG. 18 illustrates a screenshot of a live participant screen of the system of FIG. 1, according to an embodiment of the present invention.

FIG. 19 illustrates a screenshot of an add further idea screen of the system of FIG. 1, according to an embodiment of the present invention.

FIG. 20 illustrates a screenshot of a challenge control screen of the system of FIG. 1, according to an embodiment of the present invention.

FIG. 21 illustrates a screenshot of a feedback screen of the system of FIG. 1, according to an embodiment of the present invention.

FIG. 22 illustrates a facilitated online brainstorming method, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

Embodiments of the present invention are disclosed which provide facilitated online brainstorming tools, systems and methods. These brainstorming tools, systems and methods may be adapted for use in other types of ideation, including brainwriting, the KJ method and theory of inventive problem solving (TRIZ).

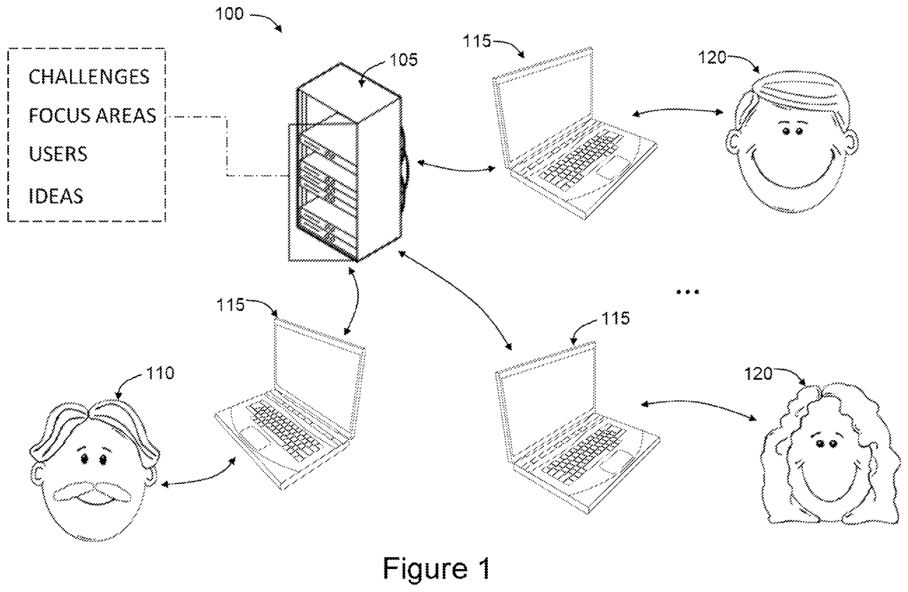

FIG. 1 illustrates a facilitated online brainstorming system 100, according to an embodiment of the present invention. The system 100 enables challenges to be defined and solved using collaborative methods, and enables brainstorming to be performed without requiring a facilitator or specialised training of participants.

The system 100 enables a plurality of challenges to be defined, in relation to which brainstorming activities are performed. In particular, the system includes a server 105 with which challenge administrators 110 interact using computing devices 115. The challenge administrator (or creator) 110 enters details of the challenge in a manner that is guided by the system 100, which includes defining a plurality of focus areas associated with the challenge.

The challenge and the associated focus areas are then stored on the server 105.

A plurality of participants 120 also interact with the server 105 using a respective computing device 115. The participants 120 may be allocated to a challenge, or be able to select challenges. Details of the participants 120 (users) are also stored on the server 105, and the server 105 allocates focus areas to participants.

The participants 120 are also guided by the system 100, and are prompted to provide ideas in relation to their focus area, as outlined in further detail below.

The ideas of the different participants 120 are also stored on the server 105, and ideas are later allocated to other participants 120 for expansion and review. In particular, participants 120 are allocated ideas of others, including in other focus areas, for expansion, review and feedback.

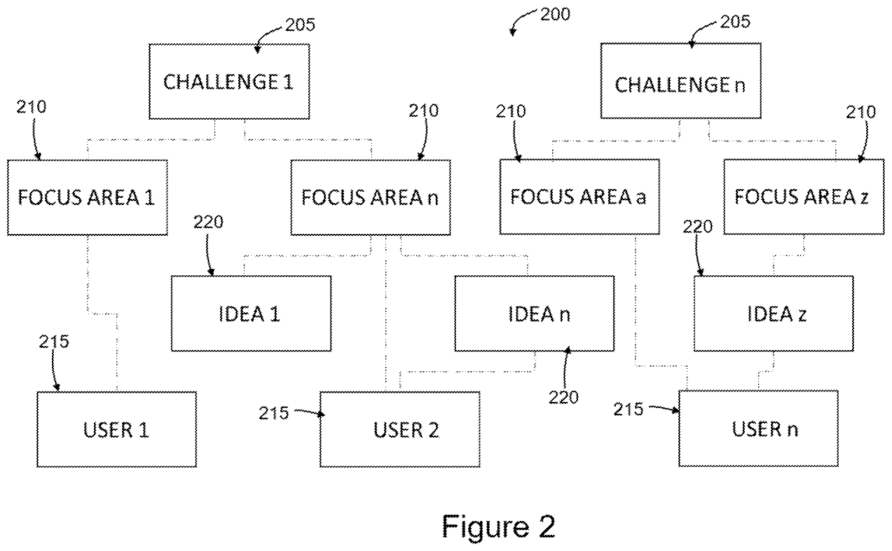

FIG. 2 illustrates an exemplary data structure 200 of the server 105, including a plurality of challenge elements 205, each corresponding to a unique challenge. Each challenge element 215 is associated with a plurality of focus area elements 210, corresponding to different focus areas. The focus areas may be customised to the challenge, and ensure that different and important aspects of the challenge are considered.

The data structure 200 further includes a plurality of participant (user) elements 215, corresponding to participants (users) of the system. Each participant element 215 is associated with a focus area element 210, indicating an allocation of the corresponding focus area to the participant. Each participant may be allocated to a focus area in any suitable way, including based upon past activity or experience, or simply randomly.

Finally, the data structure 200 includes a plurality of idea elements 220, each associated with a participant element 215. The ideas may be associated with participants in a number of ways, including as a creator of the idea, and as a critic or contributor of the idea.

As such, the data structure not only defines each of the challenges, focus areas, participants and ideas, but also the relationship or association therebetween.

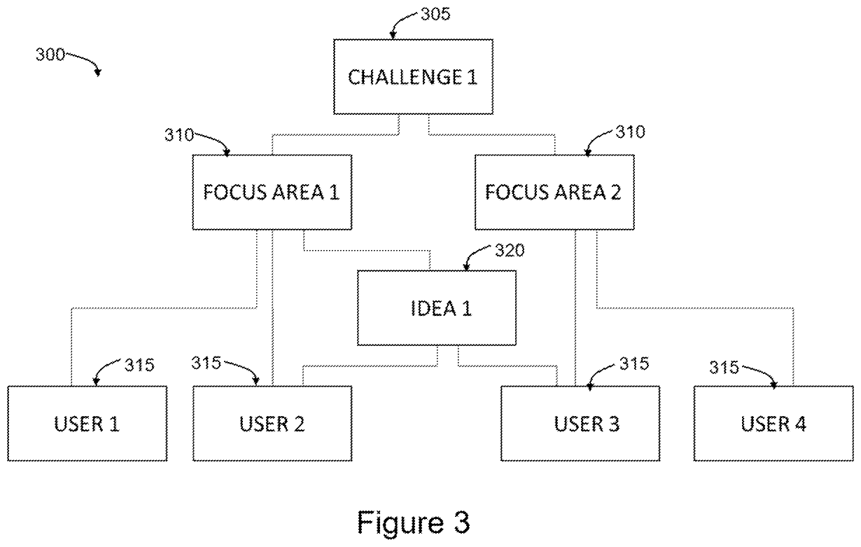

FIG. 3 illustrates a simplified exemplary scenario 300 of the system 100, which is described with reference to FIGS. 1 and 4-13.

Initially, a challenge administrator (or creator) 110 is provided with an interactive user interface which assists the challenge administrator (or creator) 110 in defining a challenge 305 and associated focus areas 310.

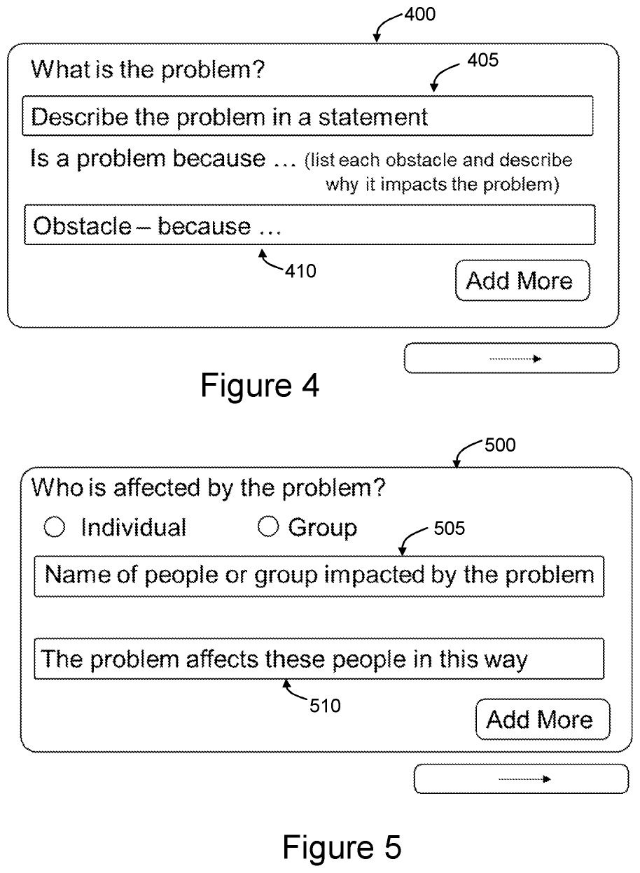

FIG. 4 illustrates a screenshot 400 of a problem description screen of the system 100, according to an embodiment of the present invention.

The problem description screen includes a problem statement field 405, for entering a problem statement, and an obstacle description field 410, for entering details of obstacles.

As an illustrative example, the problem may relate to a shortage of resources to make face masks during a pandemic, and the obstacles may include that lack of masks may cause the public to use medical masks, resulting in medics not having masks and getting sick.

The problem description screen assists in understanding the problem, and ensuring that the source of the issue is correctly identified. This is important because if the problem is not correctly defined, efforts may be focused on treating a symptom, rather than the cause of the problem.

The system 100 then presents the problem and obstacles, as entered by the challenge administrator (or creator) 110, but reformulated as a problem description. This enables the challenge administrator (or creator) 110 to review the problem statement, and update this, as required.

The challenge administrator (or creator) 110 is then prompted to enter details of who is impacted by the problem.

FIG. 5 illustrates a screenshot 500 of a problem impact screen of the system 100, according to an embodiment of the present invention.

The problem description screen includes an impacted persons field 505, for entering a name of persons (or a group of persons) impacted by the problem, and a problem affects field 510, for entering details of how the problem affects the persons.

The impacted persons field 505 and problem affects field 510 may be duplicated any number of times to enter details of different persons (or groups of persons), and how the problem affects the persons (or groups of persons). The challenge administrator (or creator) 110 is prompted to add as many persons or groups that are critical to resolving the problem.

As an illustrative example, and continuing from above, medical personnel may be affected by a lack of protective equipment.

The problem impact screen assists in understanding who is impacted by the problem, which is important for developing strategies, and also to determine if any unexpected resources may be available to use.

The system 100 then presents the impacted persons and affects, as entered by the challenge administrator (or creator) 110, but reformulated as statements. This enables the challenge administrator (or creator) 110 to review the persons and affects, and update these, as required.

The challenge administrator (or creator) 110 is then prompted to enter details of assumptions of the problem.

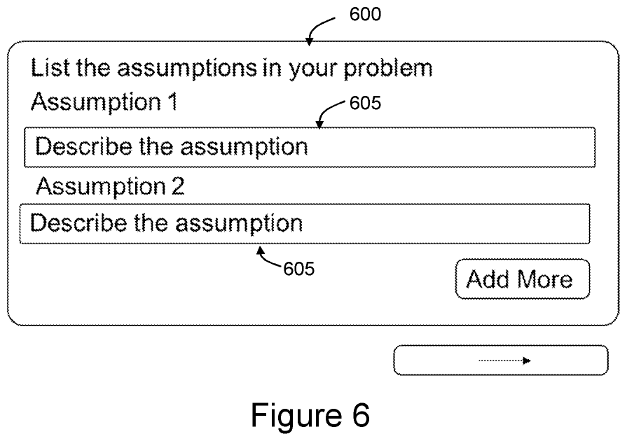

FIG. 6 illustrates a screenshot 600 of a problem assumptions screen of the system 100, according to an embodiment of the present invention.

The problem assumptions screen includes assumption fields 605, for entering details of assumptions relating to the problem. Two assumptions fields 605 are provided by default, but the assumptions fields 605 may be duplicated any number of times to enter details of any number of assumptions.

As an illustrative example, and again continuing from above, assumptions may include that PPE (including masks) must be used by medical personnel, and that masks must be made of fabric and elastic.

The problem assumptions screen assists in identifying any assumptions of the problem, which is important when developing new ideas.

The system 100 then presents the assumptions, as entered by the challenge administrator (or creator) 110, to enable the challenge administrator (or creator) 110 to review the assumptions, and update these, as required.

Finally, the challenge administrator (or creator) 110 is prompted to enter focus areas relating to the problem.

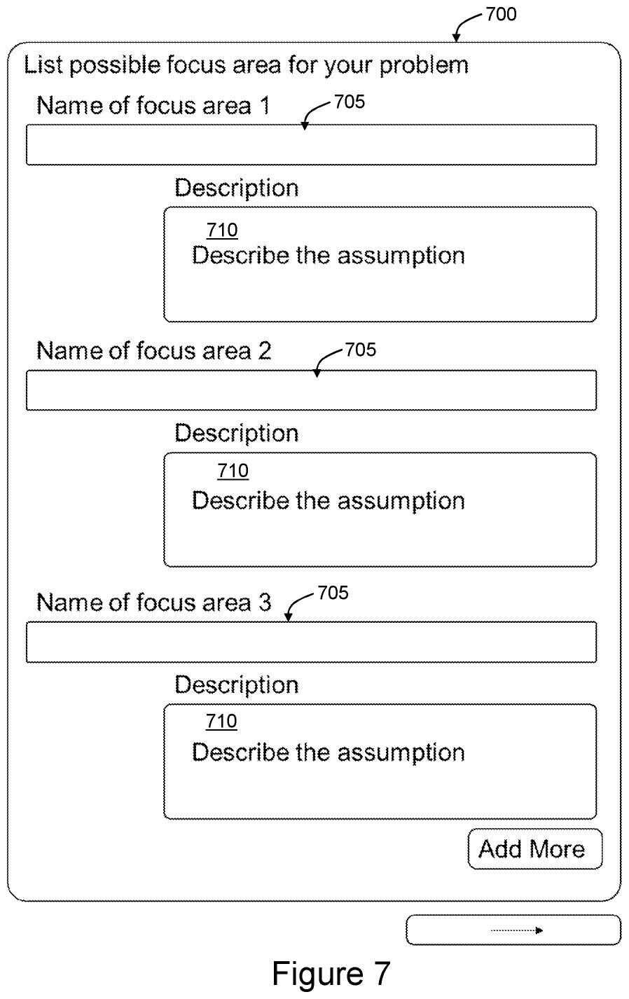

FIG. 7 illustrates a screenshot 700 of a problem focus areas screen of the system 100, according to an embodiment of the present invention.

The problem focus areas screen includes a focus area name field 705, for entering a name of a focus area, and a focus area description field, for entering a description associated with the focus area. The pairs of focus area name and description fields 705, 710 are provided by default, but the pairs of focus area name and description fields 705, 710 may be duplicated any number of times to enter as many focus areas as desired.

As an illustrative example, and again continuing from above, focus areas may include (but are not limited to) focus areas relating to reuse and recycling, cost, materials and speed.

The problem focus areas screen assists in breaking the problem down into components, with a view of addressing each of multiple aspects of the problem. As outlined below, this also enables participants to be allocated to a focus group, which maximises the breadth of thinking and ensures that the overall challenge is considered from multiple aspects.

The system 100 then presents the focus areas and their associated description, as entered by the challenge administrator (or creator) 110, to enable the challenge administrator (or creator) 110 to review the assumptions, and update these, as required.

As this stage, the system 100 may also present all aspects of the challenge, as entered by the challenge administrator (or creator) 110, for final review, prior to finalisation and publication.

In addition to that illustrated above, the system may collect any suitable details about the challenge including a time period of the challenge, images or other materials relating to the challenge, details of the challenge administrator (or creator) 110, requirements of participants, whether the challenge is public or private, or any other suitable information.

The process outlined above assists the challenge administrator (or creator) 100 in understanding the problem, including the source of any issues, who is impacted, and what assumptions are being made. This in turn assists the challenge administrator (or creator) 110 in identifying focus areas, which are used to ensure that participants 120 focus on different areas of the problem (i.e. from perspectives), and to ensure that the participants 120 are given a concrete aspect to focus on.

Now turning back to FIG. 3, while only two focus areas 310 are illustrated, the skilled addressee will readily appreciate that any suitable number of focus areas may be provided, including four focus areas. In large group brainstorming sessions and with complex challenges, it may be desirable to have many focus areas. In smaller groups, or with simpler challenges, fewer focus areas may be desirable.

A plurality of participants 315, which may correspond to the participants 120, but of which there are four, are each associated with a focus area 310. The participants 315 may be associated with the focus areas 310 based upon their past activity or experience. As an illustrative example, a participant with experience in cost reduction may be associated with a cost focus area. Alternatively, or additionally, participants 410 may be randomly allocated to focus areas, or allocated in any suitable manner.

Each participant 315 is provided with an interactive user interface which assists the participant 110 in contributing to the challenge.

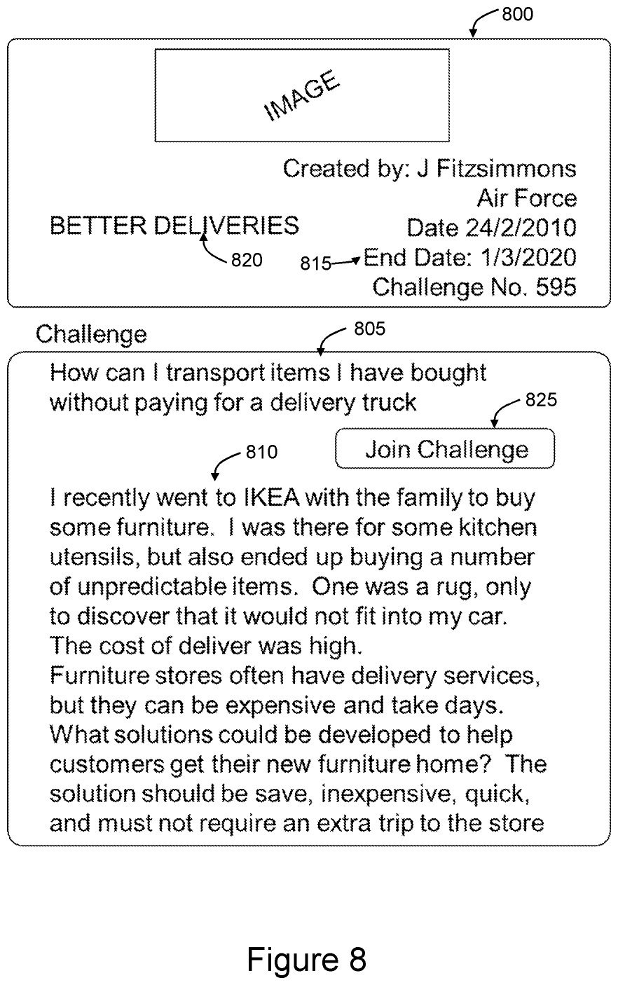

FIG. 8 illustrates a screenshot of a challenge introduction screen of the system 100, according to an embodiment of the present invention.

The challenge introduction screen may be provided to a participant 315 when a challenge is created, and the participant 315 is allocated to the challenge, or upon browsing multiple challenges. In such case, the participant may choose which challenges he or she takes part in.

The challenge introduction screen includes a challenge title element 805, and a corresponding challenge description element 810. These fields are generated based upon the information provided by the challenge administrator (or creator) 110 as outlined above, and according to one or more templates.

The challenge introduction screen further includes a challenge details element 815, including details of the creator of the challenge (i.e. details of or associated with the challenge administrator (or creator) 110), and a challenge end time. The use of an end time is particularly useful in applying pressure in a challenge to receive results in a well-defined time period.

The challenge introduction screen includes an image element 820, comprising an image relating to the challenge, which is particularly useful in attracting participants and illustrating the challenge, particularly in a system with many challenges in which participants may participate.

Finally, the challenge introduction screen includes a join challenge button 825, enabling a participant to take part in the challenge.

When a participant joins a challenge, either voluntarily, or through allocation of the participant to the challenge, a problem detail screen is provided.

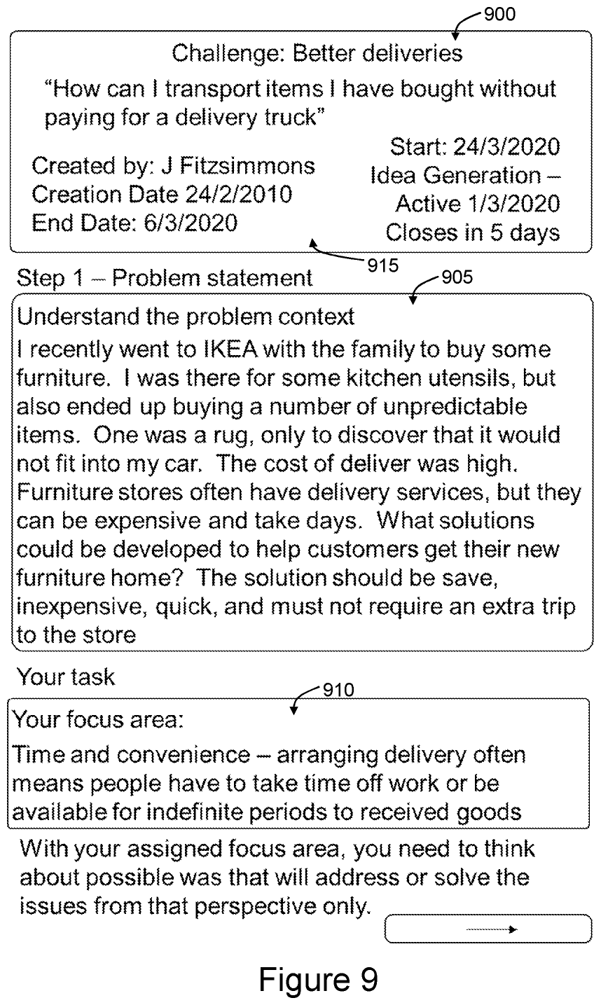

FIG. 9 illustrates a screenshot 900 of a problem detail screen of the system 100, according to an embodiment of the present invention. The problem detail screen gives the participant detail of the problem, including background, to enable the participant to understand the problem.

The problem detail screen includes a problem statement element 905, which includes a detailed problem statement, and a focus area element 910, which describes the focus area to which the participant has been allocated. In short, the problem detail screen is customised for the participant according to which focus area the participant has been allocated. This may be performed using templates.

Finally, the problem detail screen includes a challenge header 915, including a name of the challenge and details of the challenge. The challenge header 915 repeats itself across all screens to the participant, but has been removed from the remaining screenshots for the sake of clarity.

The participant is then provided with an idea creation screen, to enable the participant to document ideas relating to the problem and focus area.

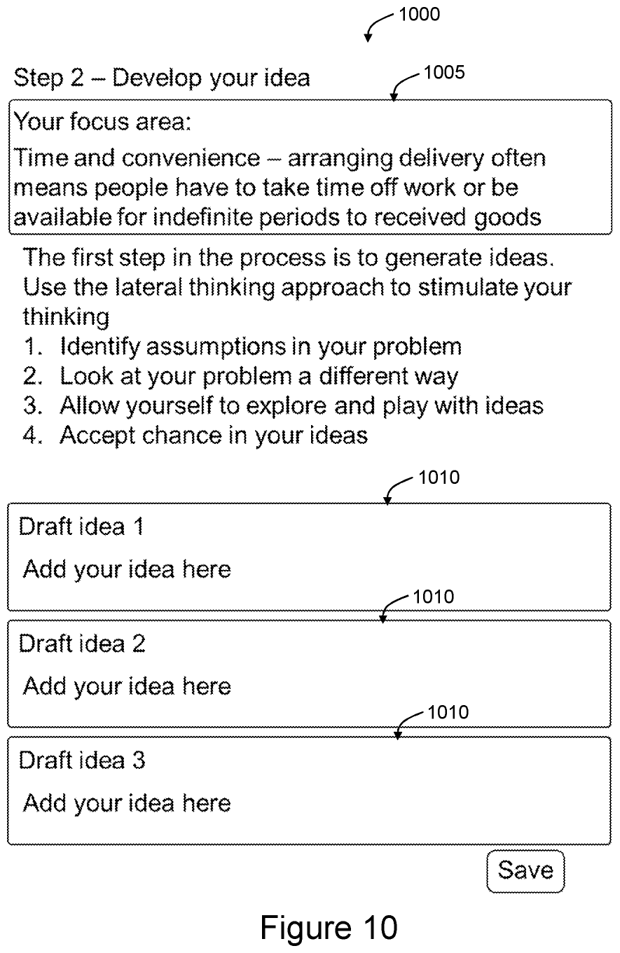

FIG. 10 illustrates a screenshot 1000 of an idea creation screen of the system 100, according to an embodiment of the present invention.

The idea creation screen includes a focus area element 1005, to emphasise the focus area to the participant, and a plurality of draft idea elements 1010, in which the participant is prompted to enter draft ideas.

The idea creation screen includes instructions to the participant, including to use a lateral thinking approach to stimulate thinking, and to not judge ideas at this stage, but instead focus on idea generation.

Once the participant has entered the draft ideas, an idea development screen is provided.

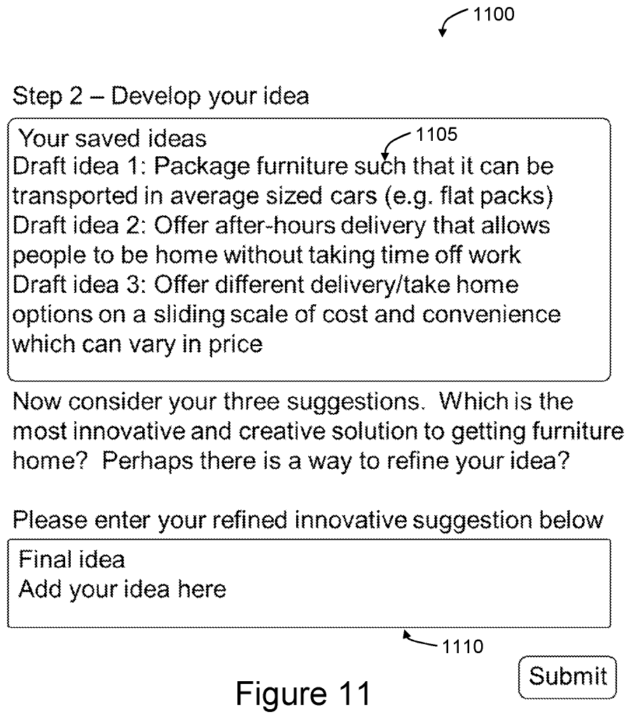

FIG. 11 illustrates a screenshot 1100 of an idea development screen of the system 100, according to an embodiment of the present invention.

The idea development screen includes a draft ideas element 1105, presenting the draft ideas of the participant, and a final idea element 1110, in which the participant is prompted to enter his or her final idea.

The idea development screen includes instructions to the participant, including to identify the most innovative and creative solution, and to consider integrating and/or refining the draft ideas.

The idea development screen, or any other screens with which the participant interacts, may use artificial intelligence to assist participants having difficulty in creating or refining ideas. In such case, the participants may be encouraged with the system providing examples of ideas or variations of ideas generated using artificial intelligence.

Once the participant has entered his or her final idea, it saved as an idea 320 and associated with the participant 315 and focus area 310.

With reference to FIG. 3, the participant USER 2 was allocated focus area 1, and generated IDEA 1 for focus area 1.

In addition to entering ideas, participants are also prompted to expand on ideas of others and rate other's ideas, as outlined below.

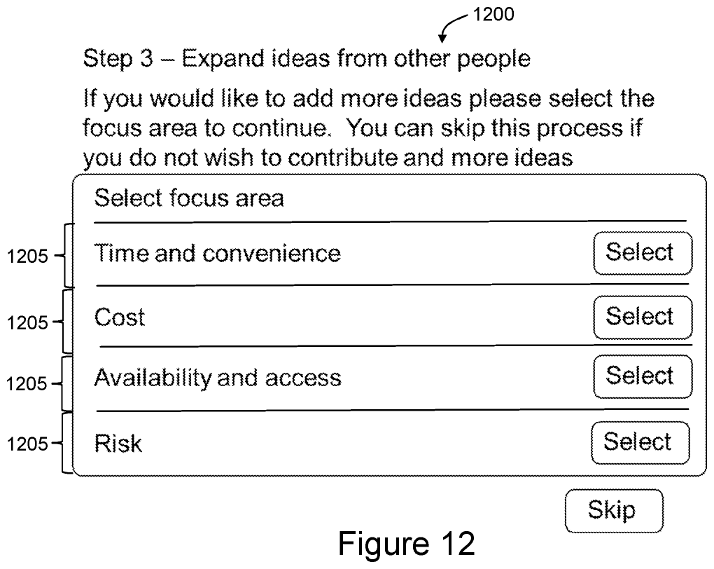

FIG. 12 illustrates a screenshot 1200 of a first ideas expansion screen of the system 100, according to an embodiment of the present invention.

The first ideas expansion screen includes a plurality of focus area elements 1205, each of which is selectable to enable the participant to select a focus area to expand ideas on. This is particularly useful when expansion of ideas is voluntary, as it enables the participant to choose to expand on ideas from a particular focus area which may be of particular interest to the participant.

Once the participant has selected a focus area, or in the case a focus area has been allocated to the participant, a plurality of ideas are shown to the participant, and the participant is prompted to add their suggestions to the idea.

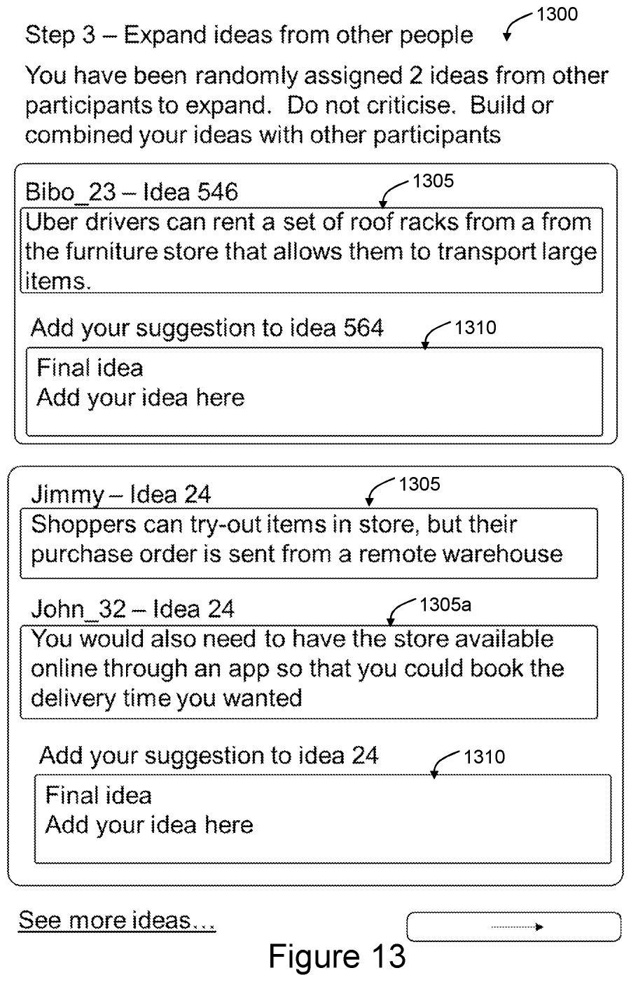

FIG. 13 illustrates a screenshot 1300 of a second ideas expansion screen of the system 100, according to an embodiment of the present invention.

The second ideas expansion screen includes a plurality of idea elements 1305 relating to the focus area, which correspond to ideas of other participants. In case there are many ideas, ideas may be randomly assigned to the participant for expansion, or assigned according to one or more metrics (e.g. a rating of the idea).

An idea suggestion element 1310 is associated with each idea, and the participant is prompted to enter his or her suggestions for the idea into the idea suggestion element.

In case other suggestions have already been made, an idea may be presented as a base idea in an idea element 1305, and a supplementary idea in a supplementary idea element 1305a. Such configuration is useful in ensuring that all developments of an idea are considered when expanding ideas.

The idea suggestions are provided to the participant that created the idea, enabling that participant to take such suggestions on board and further develop his or her idea. Similarly, the idea suggestions are saved in association with the original idea.

Finally, the participants are prompted to rate ideas. These ideas may be the same or different to the ideas that they have expanded on earlier.

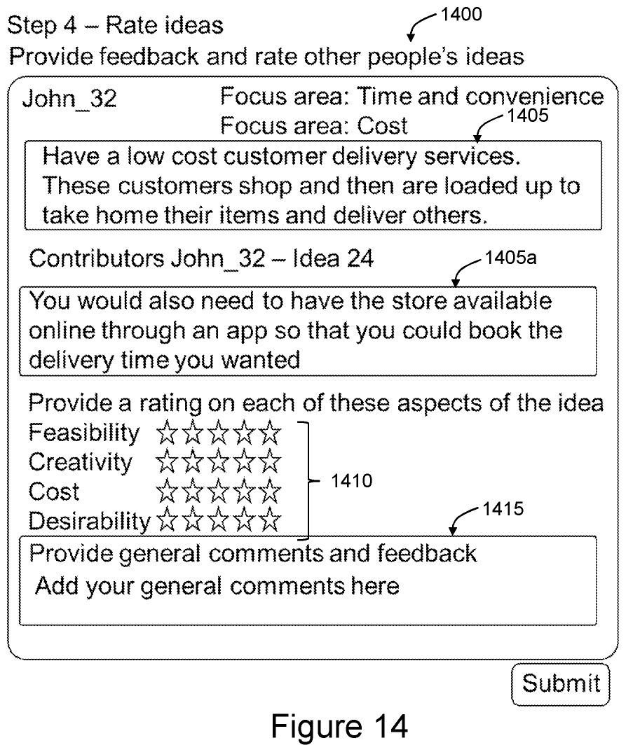

FIG. 14 illustrates a screenshot 1400 of an idea rating screen of the system 100, according to an embodiment of the present invention.

The idea rating screen includes an idea element 1405 which corresponds to an idea of another participants which is to be rated. In case suggestions have been made, a supplementary idea may be provided in a supplementary idea element 1405a.

The idea rating screen further includes a rating element 1410, which includes star rating elements for each of a plurality of aspects, including feasibility, creativity, cost and desirability, however other criteria which will enable the assessment of the idea by the challenge creator or a potential investor/sponsor may be used. As such, the participant is able to rate the idea based upon each of these aspects, which assists the creator of the idea in interpreting the rating.

Finally, the idea rating screen includes a general comment field 1415, which enables the participant to provide general comments and feedback as free text.

The system 100 collates ideas and ratings, and creates a leader board for ideas based upon the ratings.

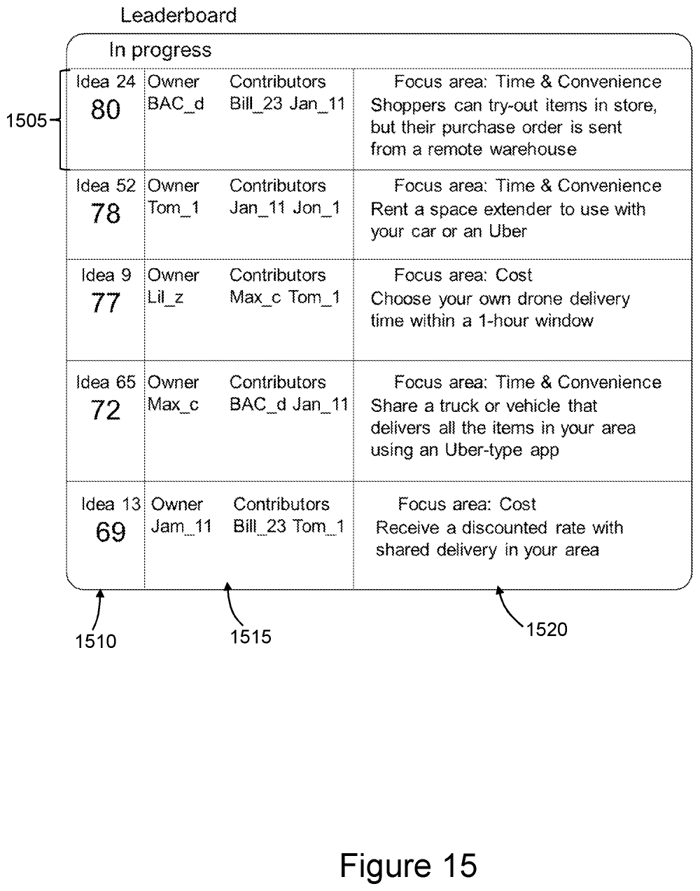

FIG. 15 illustrates a screenshot of an idea leader board screen of the system 100, according to an embodiment of the present invention.

The idea leader board screen includes a plurality of idea elements 1505, ordered according to an associated rating.

In particular, each idea element includes a rating sub-element 1510, illustrating a rating of the idea, a creation sub-element 1515, illustrating a creator of the idea, and if relevant, any contributors, and an idea description sub-element 1520, illustrating a description of the idea.

The leader board provides an efficient means for persons to see the “top” ideas for a particular challenge.

Similar leader boards may be provided for other aspects of the system, such as leader boards identifying participants that have the highest average ratings, highest participation rates, or any other suitable rating or ranking. In one embodiment, artificial intelligence may be used to take into account a history of success of participants, and may give ideas from high ranking participants more prominence in group assessment.

The system 100 is useful for both participants that participate as part of their work, and those that participate voluntarily. In some embodiments, the participants are provided with points for each idea that they create, contribute to and/or rate. Similarly, points may be allocated when ideas are successful (e.g. chosen for further development).

In such case, the participants may be ranked or receive bonuses according to the points. For example, the participants may receive rewards such as badges or other form of acknowledgement to show their participation and contribution to the quality, quantity or success of ideas. As a result, participating in the system is gamified, which encourages participants to participate and use the system 100.

As outlined above, participants may be allocated to focus areas according to any suitable metric. In some embodiments, participants are allocated to focus areas based upon their ranking, where high priority challenges have highest ranked participants allocated to them.

As outlined above, the challenges can be given a time limit. Similarly, actions of participants can be given time limits. This can be particularly useful in adding pressure to a participant that may otherwise procrastinate.

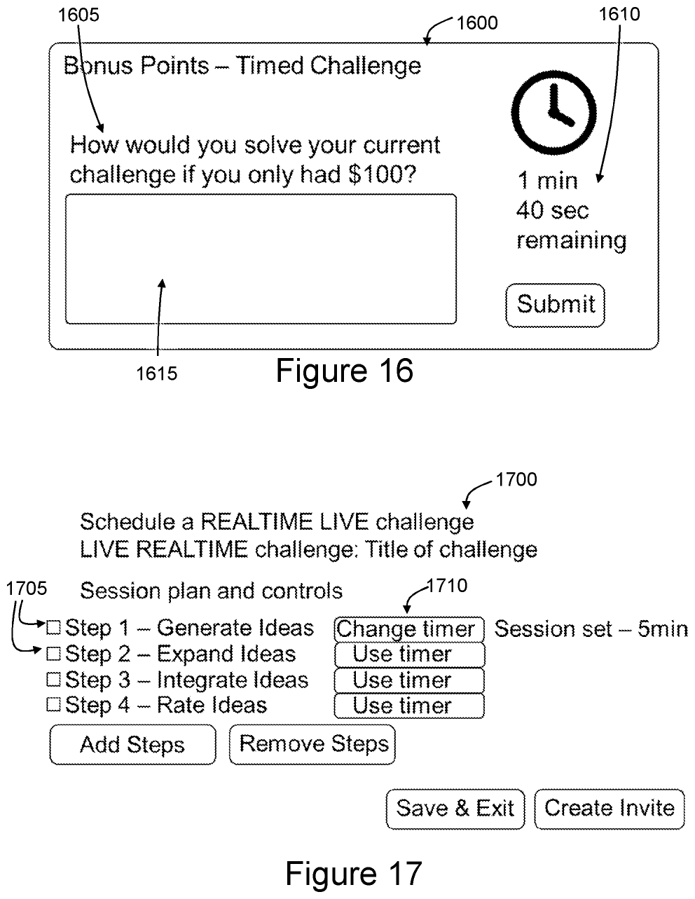

FIG. 16 illustrates a screenshot 1600 of a bonus timed challenge screen of the system 100, according to an embodiment of the present invention.

The bonus timed challenge screen may appear during any non-timed activity of the system 100 (or even timed), to assist the participant in thinking in a more spontaneous manner, and adding further variation to the participant's input.

The bonus timed challenge screen includes a question statement 1605, indicating the question to be answered in the timed challenge, and a timer element 1610, indicating how long the participant has to answer the question.

The timer element 1610 is dynamic and includes an indication of how long remains of the time. As an illustrative example, a timed challenge for 1 minute may include a timer counter down from 60 seconds.

Finally, the bonus timed challenge screen includes a text box 1615, enabling the participant to enter an answer to the question.

The bonus timed challenge screen may automatically disappear when the allocated time has been completed, or when an answer has been provided, which occurs earlier.

In some embodiments, the system may be used to schedule real time challenges, which may be supported by a facilitator. In such case, interaction with the system may be done in a similar manner, but wherein each step is being performed at the same time by the participants.

FIG. 17 illustrates a screenshot of a live challenge scheduling screen of the system, according to an embodiment of the present invention. The live challenge scheduling screen may be used by the facilitator to define the challenge.

The live challenge scheduling screen includes a plurality of step elements 1705, which define the challenge. The steps include steps such as generating, expanding, integrating and rating ideas, and may include any number of iterations.

Each step element is associated with a timer toggle 1710, which enables the facilitator to choose between manually stepping through the steps or using a timer to step between the steps.

Timers are particularly suited for inexperienced facilitators, as they ensure that steps are performed within a pre-set period, and thereby avoid time overruns. Manual control, on the other hand, is well suited to experienced facilitators, who may be able to identify more accurately when participants may be best suited to move to the next step.

The system may include a calendar, enabling the facilitator to invite participants, and schedule a time for the challenge. This is important when running a live challenge, as the participants need to take part at the same time to ensure that the ideas are able to be expanded upon, integrated and rated by each other.

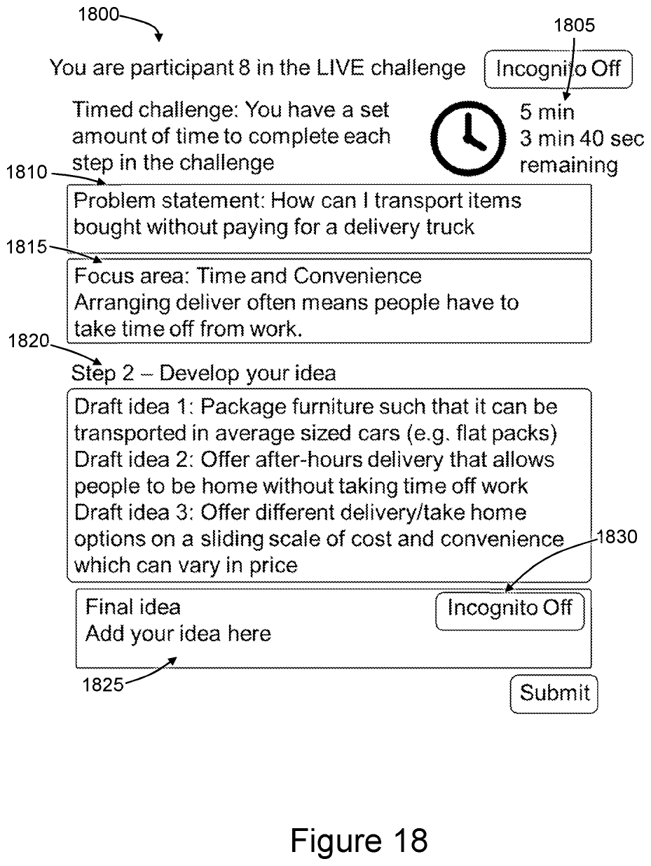

FIG. 18 illustrates a screenshot 1800 of a live participant screen of the system, according to an embodiment of the present invention.

The screenshot 1800 illustrates an idea development step, but the skilled addressee will readily appreciate that similar screens may be used for the other steps, and the screens will take the participant through each of the steps.

The live participant screen includes a timer element 1805, similar to the timer element 1610, which enables the participant to easily see how much time remains in the step.

In this case, the screen includes a problem statement element 1810, a focus area element 1815, and a draft ideas element 1820, to enable the participant to easily see the problem, their focus area and their draft ideas.

The screen includes a final idea text field 1825, enabling the participant to enter their final idea. The final idea text field 1825 is associated with an incognito button 1830, which enables the participant to enter their final idea anonymously (i.e. without other participants knowing from whom the idea came).

The system may be configured to prompt the participant to enter multiple ideas (or entries) at each step, or one or more of the steps.

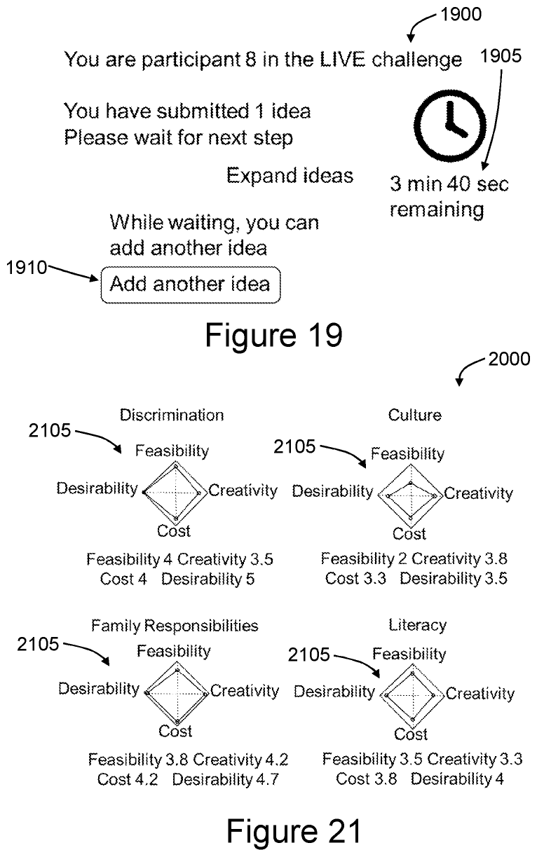

FIG. 19 illustrates a screenshot 1900 of an add further idea screen of the system, according to an embodiment of the present invention.

The screen acknowledges the participants previously submitted idea(s), and includes a timer element 1905 (similar to the timer element 1805), indicating a time left in the step. The screen prompts the participant to add another idea, and includes an add idea button 1910 for this purpose.

The system includes a challenge control screen, to enable the facilitator to control the challenge and see outcomes of the participants.

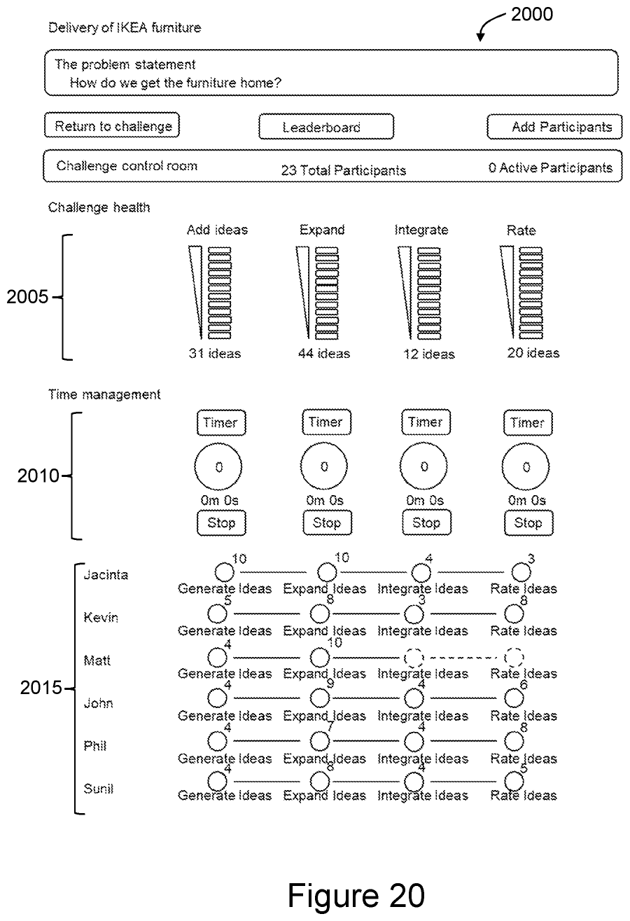

FIG. 20 illustrates a screenshot 2000 of a challenge control screen of the system, according to an embodiment of the present invention.

The control screen includes a challenge health element 2005, which includes a health element for each of the steps, indicating a health of each of the steps. In this sense, health of the steps relates to interaction from the participants, and may be based upon number of interactions.

For example, health of an “add ideas” step may be based upon a total number of ideas submitted. Similarly, health of an “expand ideas” step may be based upon a number of expanded ideas relative to the number of ideas previously submitted.

In short, “health” relates to the number of ideas generated to ensure a good outcome for that part of the process. The health of the process is particularly important when expanding ideas (typically the second step) as a minimum number of ideas per person and a minimum number of overall ideas is required for there to be a smooth flow of allocation of ideas. If an insufficient number of ideas is generated, for example, a bottleneck might be created forcing some people to miss out on contributing to the process, which is clearly undesirable. A issue may happens at the rating step, where several ratings are desirable for each idea.

The control screen includes a time management element 2010, which includes a time element for each of the steps. The time element enables the facilitator to see a time-base progress of the relevant step, and allows the facilitator to end a step (thereby moving to a subsequent step).

Finally, the control screen includes a participant progress element 2015, which includes a plurality of participant elements, and an indication of their participation in each of the steps. The participant progress element 2015 simplifies the process of identifying participants that are struggling, and enables intervention or assistance to be provided where it is needed.

Each of the participant elements may be selectable to obtain further detail on the participant, and their activity in the challenge.

In addition to receiving input from the participants, the system is also configured to provide feedback to the participants or in relation to the participants. FIG. 21 illustrates a screenshot 2100 of a feedback screen of the system, according to an embodiment of the present invention.

The feedback screen includes a plurality of focus areas elements 2105, each relating to a focus area of the associated challenge. Each focus area element 2105 graphically illustrates feedback in relation to each of a plurality of feedback aspects, such as feasibility, creativity, desirability and cost. These feedback aspects correspond to aspects where the participants are to provide feedback in relation to each other's ideas.

In this case, it can be seen that the participant(s) received their lowest scores in relation to feasibility of the ideas in the “culture” focus area.

The feedback screen can be provided for a single participant, and may be calculated across several challenges, or a group of participants, such as all participants in a single challenge.

While the above description guides the challenge administrator (or creator) and participants when entering data, and relies on data entered by the challenge administrator (or creator) and participants, in other embodiments, artificial intelligence (AI) and/or machine learning may be used to predict focus areas, or otherwise analyse input from the challenge administrator (or creator) and participants, and provide insight in relation thereto.

In particular, artificial intelligence may be used to identify patterns in problem definitions, focus areas and in solutions, proving a suggested direction for idea generation. Similarly, artificial intelligence may be used for enhanced problem identification, generation of more ideas for problem solving tasks, suggestions for enhancements for those ideas and generation of prompts on particular subjects to assist participants. The data may also be used to explore and understand the patterns in idea generation and to predict and identify initial solution sets for new problems.

Artificial intelligence may also be used to cluster or categorise ideas (based on semantics) or results to enable an understanding of popular or repetition of similar ideas. As an illustrative example, artificial intelligence may identify a previously solved problem that is similar to a defined problem, and provide or propose ideas, focus points or the like, to springboard ideas.

Similarly, artificial intelligence may be used to identify innovators that are high scoring in a particular area where a challenge is lacking, or would improve with input in that area. This enables participants to be allocated to challenges in a manner that is more likely to result in quality results for the challenges as a whole.

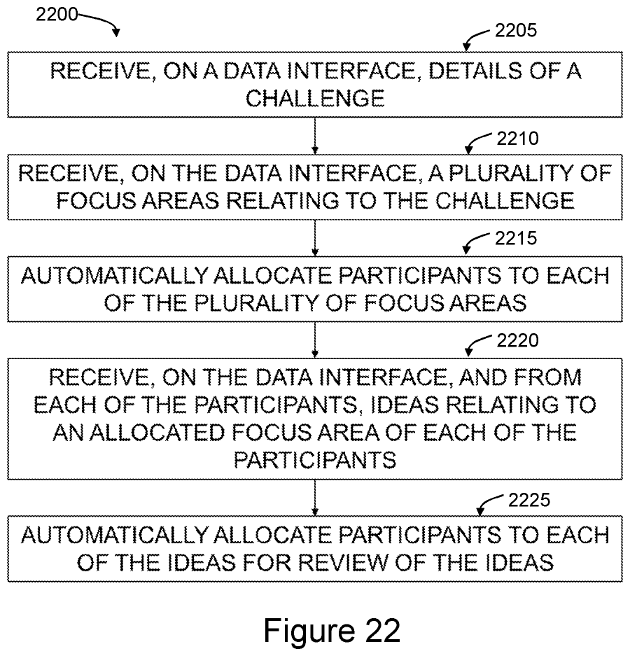

FIG. 22 illustrates a facilitated online brainstorming method 2200, according to an embodiment of the present invention. The method 2200 may be similar or identical to the method performed by the system 100.

At step 2205, details of a challenge are received on a data interface. The details may include a problem description, and various other aspects of the challenge, and may be input as part of an interactive graphical user interface, as outlined above.

At step 2210, a plurality of focus areas relating to the challenge are received on the data interface. The focus areas may be input as part of the graphical user interface. Alternatively, or additionally, artificial intelligence and/or machine learning may be used to at least partly define the focus areas, or to assist a participant in selecting or defining focus areas.

At step 2215, participants are automatically allocated to each of the plurality of focus areas. The participants may be allocated in any suitable manner including randomly, and according to past activity of the participant (e.g. a ranking of the participant).

At step 2220, ideas relating to an allocated focus area of each of the participants are received, on the data interface, and from each of the participants. The ideas may be provided as part of an interactive graphical user interface as outlined above.

At step 2220, participants are automatically allocated to each of the ideas for review of the ideas. The review may include expanding and/or rating ideas. In particular, the participant may be provided with a user interface that prompts the participant to add suggestions to each of a plurality of different ideas, from different participants, and finally rate and provide feedback for each of the ideas.

By allocating participants to different focus areas ensures that the participants focus on different areas of the problem and have something concrete to focus on. This is particularly useful for inexperienced participants who may have difficulty focusing on a problem broadly, as such problems may initially appear to be insurmountable.

Each participant may be prompted to generated ideas, develop the idea and ultimately upload the idea by the interactive graphical user interface which assists the participant in developing his or her ideas. by prompting the participant to create several draft ideas prior to creating a final idea for submission.

Such process is important in that it stimulates thinking, particularly creative thinking, and may overcome blocks that may otherwise occur.

As outlined above, artificial intelligence may be used to provide predictions in a variety of aspects of the system. In certain embodiments, artificial intelligence may be used to understand meaning behind language and categorise ideas (or other data) based thereon. This can be used to group ideas, for example.

Similarly, artificial intelligence may be used to predict popularity of ideas, focus area, or any other aspect of the system. This may then be used to assign participants to ideas or focus groups based upon predicted popularity, or for any other purpose.

As an illustrative example, the method may be initially performed with a large number of participants and ideas. The ideas may be ranked, and top ideas may be chosen (e.g. the top 3 or 5 ideas from each focus area). These chosen ideas may be analysed in a further round, e.g. where a large number of participants review and contribute to these chosen ideas. Such configuration enables the “best” ideas to be first identified by a large number of participants and a large number of ideas, to be ultimately developed by a large number of participants.

The method may be performed over a period of time, enabling participants to take part at different times. Similarly, the method may be performed iteratively. In other embodiments, however, the method may be performed simultaneously (live) with multiple participants performing steps simultaneously (e.g. with reference to a timer).

While the above embodiments describe use of interactive graphical user interface, in other embodiments use Virtual Reality (VR) headsets and glasses. In one embodiment VR headsets are used to provide a virtual problem solving “room” or a series of breakout “rooms” where participants can collaborate in problem solving. Virtual idea “bubbles” and idea “screens” may then be populated by participants, relating to their own ideas or ideas of others. Artificial Intelligence may also be used to generate ideas and suggestions for consideration in such scenarios.

Embodiments of the present invention described above provide a facilitated brainstorming tool, where challenges are created based on key problem definition questions that help scope, describe and understand a problem, gap or opportunity. A challenge administrator (or creator) may invite a limited group of people to participate in the challenge (a closed challenge, e.g. where invitation is via email, through social media or equivalent) or may provide open access for all to contribute. In some embodiments, participants may invite other participants.

The methods and systems described above assist the challenge administrator (or creator) in defining the challenge, as it leads the challenge administrator (or creator) through questions to correctly identify the scope of the problem, those impacted and constraints. Incorrect problem identification is a fundamental issue in successful innovation and by directing the challenge administrators to address requirements necessary for correct problem identification improves overall success when using the system.

Participants are then asked a series of questions, where they respond to stimulus that will support the idea generation process, and ultimately the definition of ideas relating to the challenge. After ideas are produced, they are peer reviewed and rated according to evaluation criteria developed to target sponsorship and investment requirements.

In some embodiments, the methods and systems provide matches based on interests, problem definitions and idea categorisation, combining a number of features to create a holistic design and innovation generation support tool—from problem identification to idea and design. As a result, the methods and systems may bridge the difficult innovation implementation gap by providing access to investors to operationalise and prototype ideas.

During this process ideas are shared (either anonymously or identified), all participants must expand on several ideas to continue in the process. Peer evaluation is then conducted through averaging the ratings provided by three or more contributors on ideas for criteria regarding feasibility, originality, cost and desirability.

In some embodiments, avatars are used to provide anonymity to each of the participants. This removes biases associated with particular individuals in the idea review and evaluation process.

Ideas are then displayed on a leader board with ratings and the expansion of ideas. This shows the contributions of specific people to the overall idea.

Reports may be generated according to various metrics of the system. As an illustrative example, challenge administrators may access reports of best ideas, combinations of features and critical evaluation.

The tool may also provide “points” to participants based upon the number of ideas they have submitted and the rating of their solutions. This may be used to generate a profile score for each participant, and profile scores can be used by administrators to invite specific contributors to special brainstorming sessions. Artificial intelligence and machine learning algorithms may assist in suggesting participants to engage in particular projects based on their profiles.

A bounty or rewards system may also be included. In particular, challenge creators/administrators may attach a bounty to the success of a challenge and reward participants with a prize or a monetary reward. The system may facilitate the posting of a bounty and the passing the bounty to the top scoring innovator(s). As an illustrative example, a bounty of $150 may be provided, distributed such that the top rated idea gets $100, the second top rated idea get $30 and the third top rated idea gets $20. The system may also enable participants to “bank” their rewards and claim them at a later time, which is particularly useful when many smaller rewards are provided.

Reports can also be provided on the contributors, showing number of ideas, expansion of ideas and the popularity of ideas. Organisations can also access data on contributors who generate the highest rated ideas and are involved in successful innovations

Investors and sponsors may also use the system to register their interest in solutions and make connections with potential entrepreneurs.

In some embodiments, data may be exported for use outside of the system. The data may be exported in any suitable format, including comma-separated values (csv), Microsoft Excel, or any other suitable format.

In some embodiments, templates may be used to format data in a particular manner. As an illustrated example, templates may be used to take one or more developed ideas, and generate pitch documents therefrom. This may be particularly useful in providing an easy to use manner for sharing successful ideas with investors or others.

Advantageously, the methods and systems described above enable brainstorming to be provided in an efficient and easy to use manner, and without requiring a facilitator, or participants with specialised training or experience. It does not require participants to travel to a common location, or even be available at a single point of time, and is not limited by group size. As such, it enables more people to participate in brainstorming.

The methods and systems may be used for crowdsourcing brainstorming for public policy design as well as for social innovation. Similarly, the systems and methods may be used within large organisations to collect, prioritise and implement innovations.

The methods and systems may reduce or remove the negative effects of traditional group work and brainstorming, whilst enhancing the range of ideas through diversity, overcoming many of the confounding factors for creativity in face-to-face brainstorming, such as social conformity, social loafing, production blocking or evaluation apprehension.

Embodiments of the invention provide transparency of innovators, showing who is generating the best ideas most of the time. This enables these innovators to be appropriately rewarded and/or used in projects.

As prioritisation and evaluation of ideas is performed by peers and participants, prioritisation and evaluation is performed as part of the process, enabling focus to be placed on promising ideas from an early stage and without requiring external evaluation.

Embodiments of the invention provide structured interfaces for both those defining problems and those participating in brainstorming. As a result, the methods and systems may ensure that necessary methodological steps are followed, without requiring a facilitator.

In particular, the methods and systems may automatically provide structured support to define and properly understand a problem before investigating solutions.

The ability for anonymity in the idea sharing and review process, e.g. through the use of avatars, means that the impact of hierarchy and politics within organisations is removed, and as ideas may be randomly assigned for review and expansion, production blocking is prevented, and ideas are prioritized and assessed on face value.

Furthermore, participants who do not contribute will be filtered out through a natural process, thereby providing visibility of social loafing.

By providing gamification of participation, intrinsic and extrinsic rewards are provided to participants to become active in the community, and they are encouraged to grow points and also access other features of the system. Higher rated participants may also be invited to special challenges. Similarly, bounties or rewards may be provided to motivate participants.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A facilitated online ideation method including:
receiving, on a data interface, details of a challenge;
receiving, on the data interface, a plurality of focus areas relating to the challenge, each focus area relating to a different aspect of the challenge;
automatically allocating participants to each of the plurality of focus areas for ideation;
receiving, on the data interface, and from each of the participants, ideas relating to the allocated focus area of each of the participants; and
automatically allocating participants to each of the received ideas for review of the ideas.

2. The method of claim 1, comprising a facilitated online brainstorming method.

3. The method of claim 1, wherein the participants are automatically allocated to the ideas for review according to a focus area associated with each of the participants.

4. The method of claim 1, wherein each of the participants is automatically allocated to one focus area for ideation, and allocated to an idea for review from another focus area.

5. The method of claim 1, wherein a participant of the participants is automatically allocated to an idea for review at least in part according to a focus area selected by the participant.

6. The method of claim 1, further comprising automatically prompting the participants to expand on the ideas for review, such that each idea is developed by multiple participants at different points of time.

7. The method of claim 1, further comprising automatically prompting the participants to rate the allocated idea for review according to a plurality of pre-defined rating options.

8. The method of claim 7, wherein the participants are prompted to rate the idea for review according to a plurality of pre-defined characteristics, such as feasibility, creativity, cost and desirability.

9. The method of claim 7, further comprising generating a leader board of ideas for the challenge based upon ratings of the ideas.

10. The method of claim 7, further comprising:
selecting one or more key ideas from the plurality of ideas according to ratings of the ideas;
automatically allocating participants to each of the key ideas for review of the key ideas; and
automatically prompting the participants to expand on the key ideas for review.

11. The method of claim 1, further comprising: receiving on the data interface, details of a plurality of challenges, and allocating participants to a challenge of the plurality of challenges.

12. The method of claim 11, further comprising: rating participants according to a rating of their ideas in relation to multiple challenges.

13. The method of claim 12, further comprising generating a leader board of participants according to their respective ratings.

14. The method of claim 11, wherein the participants are allocated to a challenge at least in part according to their previous activity and/or rating.

15. The method of claim 1, further comprising: prompting participants to enter details of a plurality of draft ideas prior to enter details of a final idea.

16. The method of claim 1, further comprising: prompting a challenge administrator (or creator) to enter the details of the challenge, the details of the challenge including: a problem statement and one or more obstacles; details of who is affected by the problem; and/or details of assumptions associated with the problem.

17. The method of claim 1, further comprising automatically generating one or more suggested focus areas according to the details of the challenge, wherein the plurality of focus areas are selected at least in part according to the one or more suggested focus areas.

18. The method of claim 17, wherein the one or more suggested focus areas are generated according to artificial intelligence and/or machine learning algorithms according to patterns in problem definitions, focus areas and in solutions.

19. The method of claim 1, wherein the participants are in different geographic regions and perform the steps of the method at different points of time.

20. A facilitated online ideation system including:
a data interface, for:
receiving details of a challenge; and
receiving a plurality of focus areas relating to the challenge for ideation; and
a processor, configured to:
automatically allocating participants to each of the plurality of focus areas;
wherein the data interface is further configured to receive, from each of the participants, ideas relating to an allocated focus area of each of the participants and wherein the process is further configured to automatically allocate participants to each of the ideas for review of the ideas.
